(19) United States
(12) Patent Application Publication
(10) Pub. No.: US 2020/0189880 A1
(43) Pub. Date: Jun. 18, 2020

(54) STATOR RAIL SEGMENT FOR THE LINEAR DRIVE OF AN ELEVATOR SYSTEM

(71) Applicants: THYSSENKRUPP ELEVATOR AG, Essen (DE); thyssenkrupp AG, Essen (DE)

(72) Inventors: Martin MADERA, Neuhausen (DE); Petros BURUTJIS, Unterhausen (DE)

(73) Assignees: THYSSENKRUPP ELEVATOR AG, Essen (DE); thyssenkrupp AG, Essen (DE)

(21) Appl. No.: 16/624,048

(22) PCT Filed: Jun. 14, 2018
(86) PCT No.: PCT/EP2018/065767

§ 371 Date: Dec. 18, 2019

(30) Foreign Application Priority Data
Jun. 21, 2017 (DE) 10 2017 005 852.0

(51) Int. Cl. B66B 7/02

(52) U.S. Cl. CPC B66B 7/026; B66B 11/0407

(57) ABSTRACT

A stator rail segment, which may be used in a linear drive of an elevator system along a drive axis, may have a predetermined segment length and may include multiple coil interfaces arranged along the drive axis for receiving a respective coil unit. A shaft interface may be configured to secure the stator rail segment in an elevator shaft at a given assembly position with respect to the drive axis. The stator rail segment may also include a position adapter for adapting an assembly position of the coil units relative to the drive axis relative to the given assembly position.

The invention relates to a stator rail segment for a linear drive of an elevator system, an elevator system with a plurality of such stator rail segments, and a method for installation of a stator rail composed of multiple stator rail segments.

A new type of elevator system, such as is described for example in WO 2012/045606, uses a linear motor for driving the elevator cars within the elevator shaft. A stator of the linear motor is secured as the primary unit to the wall of the elevator shaft and a rotor is secured as the secondary unit to the elevator cars being moved. This drive method makes it possible for multiple elevator cars to travel at the same time in the same shaft independently of each other.

Among other reasons, because the stator elements comprise a relatively heavy weight, oftentimes multiple coil units installed in series are assembled in a stator rail segment, which is secured separately each time to the shaft wall. Multiple adjacent stator rail segments connected to the shaft wall along the drive direction then form the stator rail. The use of standardized stator rail segments, especially having a given segment length, has proven to be economical, and furthermore this is advisable in adapting to the length of the rotor of the elevator cars.

The track length of the shaft track to be driven by means of the stator rail depends on an elevator system with a single elevator shaft on the building height and possibly on the position of the building floors being served by the elevator. In an elevator system in which multiple vertical elevator shafts are connected by horizontal elevator shafts, the track length may be determined from the distance between two so-called exchange sites or direction changers (intersections of a vertical and a horizontal elevator shaft).

In the construction of an elevator system, the possible assembly positions for the stator rail segments and/or for the guide rails of the elevator cars on the shaft wall are often limited to predetermined securing levels stipulated by the building owner. Typically, anchor rails for the securing of the stator rail segments and other components are provided in the elevator shafts at regular given spacings in the travel direction, running transversely to the travel direction.

Oftentimes, the spacing of the anchor rails dictated by the building does not match up with the length dimension of the standardized rail segments, as provided by the elevator system. However, in the interest of a rapid and low-cost installation, it is nevertheless desirable to avoid mounting locations away from the anchor rails.

Therefore one problem which the invention proposes to solve is to provide a stator rail segment which can be mounted in flexible manner in the elevator shaft.

This problem is solved by a stator rail segment according to claim 1 and by a method according to claim 10 and claim 11. An elevator system with multiple stator rail segments is disclosed in claim 8. Further advantageous embodiments are the subject matter of the dependent claims.

According to one aspect of the invention, a stator rail segment is provided for a linear drive of an elevator system along a drive axis—corresponding especially in an installed condition to a travel axis of the elevator system, and comprising a predetermined segment length along the drive axis.

Furthermore, the stator rail segment comprises multiple coil interfaces arranged along the drive axis for receiving a respective coil unit. The coil interfaces comprise in particular a connection for the coil unit and a securing element. The securing element may also be configured for multiple coil interfaces, such as a mounting profile.

The stator rail segment furthermore comprises at least one, especially one or two, shaft interfaces for securing the stator rail segment in the elevator shaft at a given assembly position, especially on an anchor rail, with respect to the drive axis.

The stator rail segment moreover comprises a position adapter for adapting an assembly position of the coil units relative to the drive axis in relation to the given assembly position. The adapting of the assembly position may be done in particular at the individual coil units and/or collectively at the stator rail segment.

According to another aspect of the invention, an elevator system is provided, comprising: (a) at least one shaft track running along a travel axis between two exchange sites spaced apart in the shaft, comprising in particular a predetermined track length, (b) multiple anchor rails extending transversely to the travel axis and arranged at a predetermined, especially a regular, anchor spacing for the securing of a stator rail segment to the shaft wall, (c) multiple stator rail segments secured to at least one of the anchor rails, especially according to one embodiment of the aforementioned aspect of the invention, being situated adjacent to each other along the travel axis such that their drive axes are oriented to the travel axis.

If the position adapter is formed at least on one shaft interface, the individual stator rail segments are situated each time with at least substantially the same size of air gap from the adjacent stator rail segments, so that each time one end of a stator rail segment also lies at least substantially against the two ends of the shaft track.

If the position adapter is formed each time at the coil interfaces, the individual coil units are situated each time with at least substantially the same size of air gap from the adjacent coil units, so that each time one end of a coil unit also lies at least substantially against the two ends of the shaft track.

According to another aspect of the invention, a method is provided for installation of a stator rail along a shaft track having a predetermined track length, especially by two exchange sites along the travel axis. The stator rail comprises multiple stator rail segments according to one embodiment of the first mentioned aspect of the invention, the position adapter being formed in these stator rail segments respectively at the at least one shaft interface. The method comprises the following steps:

(i) determining a maximum number of stator rail segments of a predetermined segment length which can be built along the predetermined track length, (ii) determining a remaining overall air gap from the difference between the track length and the sum of the segment lengths, (iii) dividing up the total air gap equally or possibly also unequally among all individual air gaps between two adjacent stator rail segments, and (iv) mounting the stator rail segments on the anchor rails, adapting the assembly position of each stator rail segment in the travel direction to the individual air gap, in particular extension in the travel direction to said individual air gap, so determined by means of the position adapter.

According to another aspect of the invention, another method is provided for installation of a stator rail along a shaft track having a predetermined track length, especially by two exchange sites along the travel axis. The stator rail is composed of multiple stator rail segments according to one embodiment of the first mentioned aspect of the invention, the position adapter being formed in these stator rail segments respectively at the coil interface. The method comprises the following steps:

(I) determining a maximum number of coil units of a predetermined coil length which can be built along the predetermined track length, (II) determining a remaining overall air gap from the difference between the track length and the sum of the coil lengths, (III) dividing up the total air gap equally or possibly also unequally among all individual air gaps between two adjacent coil units, (IV) mounting the coil units on stator rail segments of a predetermined segment length and depending on the track length possibly on at least one termination stator rail segment adapted to the length at one end of the shaft track, adapting the assembly position of each coil unit in the travel direction to the individual air gap so determined by means of the position adapter, and (V) mounting the stator rail segments on the anchor rails with a predetermined minimum air gap, serving especially at least substantially only for an equalizing of thermal changes or subsidence processes in the building.

The invention is based on the awareness, among other things, that the responsibility for the spacing of the anchor rails in the elevator shaft often lies with the owner of the building in which the elevator system is being erected. On the other hand, the responsibility for the dimensions of standardized rail components, such as the stator rail segments, lies with the developer of the elevator system. In the most seldom instances, the spacing of the anchor rails and the length of the stator rail segments will comprise naturally matching dimensions.

However, the installation of an elevator system is usually done in a tight time window under tight cost constraints. For these reasons, a free securing of the stator rail segments, entailing many concrete boreholes at the shaft wall, will normally not be considered. Likewise, the borehole positions can hardly be produced exactly and regularly, even though a fine tuning possibility is required.

Now, the invention is based, among other things, on the notion of adapting an air gap formed between the individual stator rail segments and/or between the individual coil units to balance out thermal effects and/or a subsidence of the building. The air gap provided between adjacent stator rail segments/coil units is formed in the direction of travel along the shaft track in such a way that, when all the air gaps between two adjacent stator rail segments/coil units are added up, these are distributed over the entire track length of the shaft track. This ensures a more uniform propulsion of the elevator cars.

In order to adapt the air gap in this way, the assembly position of the individual stator rail segments or coil units must be adaptable along the travel axis of the elevator shaft. This can be accomplished in easy manner, when the spacings between the anchor rails are dictated by the building, by providing a position adapter on the stator rail segment in accordance with the invention.

In order to allow an easy adapting of the assembly position, according to one embodiment the position adapter comprises a mounting profile with a plurality of assembly recesses spaced apart from each other along the drive axis, especially in constant manner. The particular spacing between two adjacent assembly recesses may be, for example, several millimeters or a few centimeters, especially 2 mm, 5 mm, 10 mm or 20 mm.

According to another embodiment, the position adapter may comprise at least one oblong hole running parallel to the drive axis of the motor rail segment, in order to allow an easy adapting of the assembly position.

Depending on whether the distributing of the stator components along the entire shaft track is to be done by (a) adapting the air gaps between the adjacent stator rail segments or by (b) adapting the air gaps between the individual coil units of the stator, the position adapter is formed (a) at the shaft interface(s) or (b) at the coil interfaces, regardless of which embodiment is technically implemented. Both embodiments have their advantages: the adapting of the air gaps between the stator rail segments enables an adapting with less expense; the adapting of the air gaps between the coil units enables an overall more uniform distribution of the coil units of the stator along the overall shaft track.

In order to make possible an adapting of the assembly position with little expense, according to one embodiment the position adapter is formed at the shaft interface(s).

It may be provided in particular that the stator rail segment additionally comprises a running rail bracket for guiding a running rail of the elevator system, wherein the running rail bracket comprises the shaft interface.

In order to make possible an overall more uniform distribution of the coil units of the stator along the overall shaft track, according to one embodiment the position adapter is formed at the coil interfaces. It may be provided in particular that the position adapter comprises a mounting profile, which forms the coil interfaces.

In order to make do with the least number of separate rail segments at each position along the shaft track and thereby further reduce the installation expense, according to one embodiment the stator rail segment additionally comprises a running rail segment for guiding an elevator car of the elevator system. In addition, current conductors, data conductors, inverters and/or wiring may be arranged on the segment.

According to one embodiment, the stator rail segment on the one hand and a running rail bracket or a running rail module on the other hand are separate units. The stator rail will then be mounted separately in particular, the individual stator rail segments being oriented at the bracket or module and secured in flexible manner on the bracket or module by an oblong hole system as position adapter. This represents a simple solution at the component level, yet it must be fabricated very precisely in order to maintain a tight tolerance chain.

According to another embodiment, the stator rail segment on the one hand and a running rail bracket or a running rail module on the other hand are formed jointly, so that a narrower tolerance range is sufficient. The position adapter here may be formed for example with a mounting profile at the shaft interface.

According to another embodiment, the stator rail segment on the one hand and a running rail bracket or a running rail module on the other hand are once again formed jointly. However, no adapting of the assembly position of the stator rail segments to the shaft wall is provided, but instead an adapting of the assembly position of the individual coil units by means of a position adapter arranged respectively at the coil interfaces. The position adapters may be formed, for example, as an oblong hole.

The elevator system according to one embodiment comprises at least two vertical elevator shafts, each of them being joined together at least at two exchange sites by means of a respective horizontal elevator shaft.

Further features, benefits and application possibilities of the invention will emerge from the following description in connection with the figures. There are shown, partly in schematized representation,

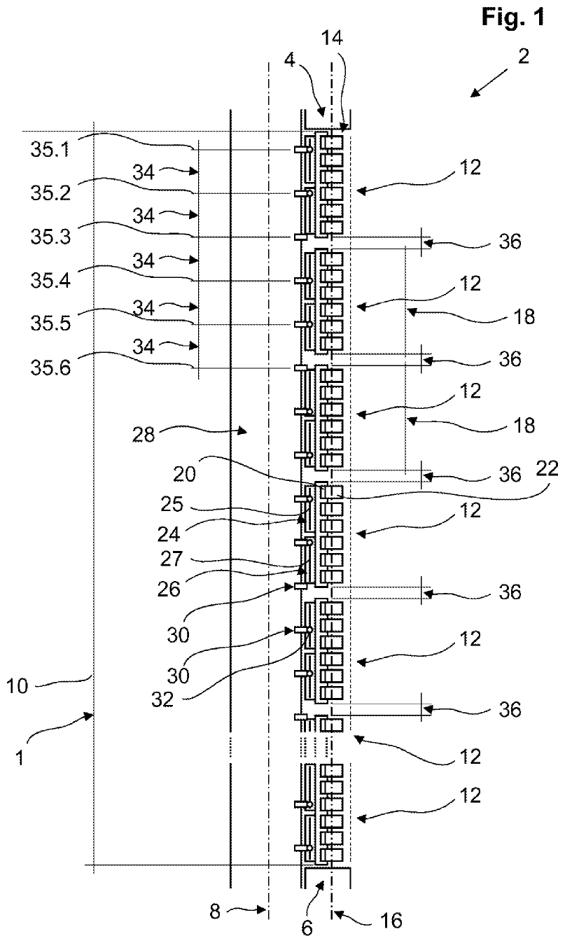

FIG. 1 a shaft track of an elevator system between two exchange sites, comprising a stator rail with multiple stator rail segments according to a first exemplary embodiment of the invention in a lateral sectional view;

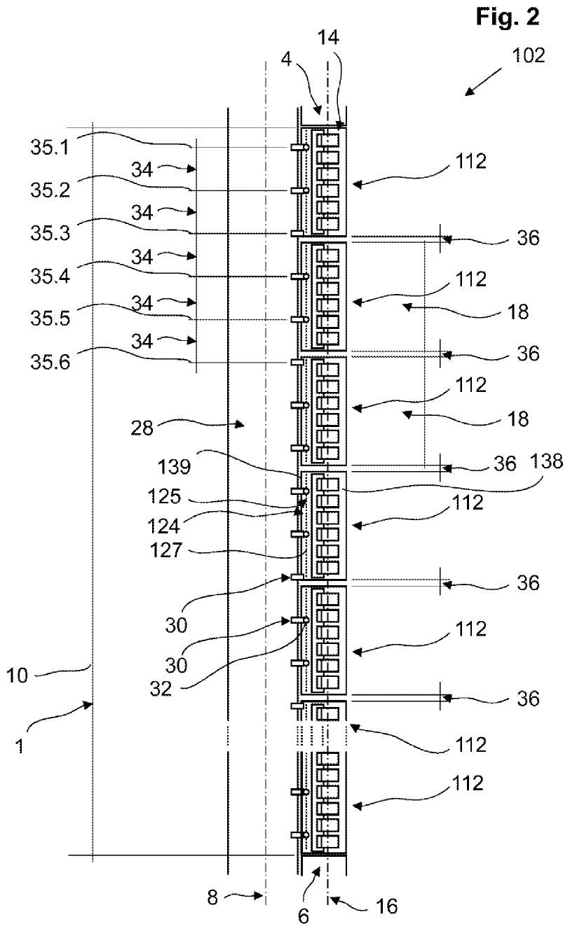

FIG. 2 a shaft track of an elevator system between two exchange sites, comprising a stator rail with multiple stator rail segments according to a second exemplary embodiment of the invention in a lateral sectional view;

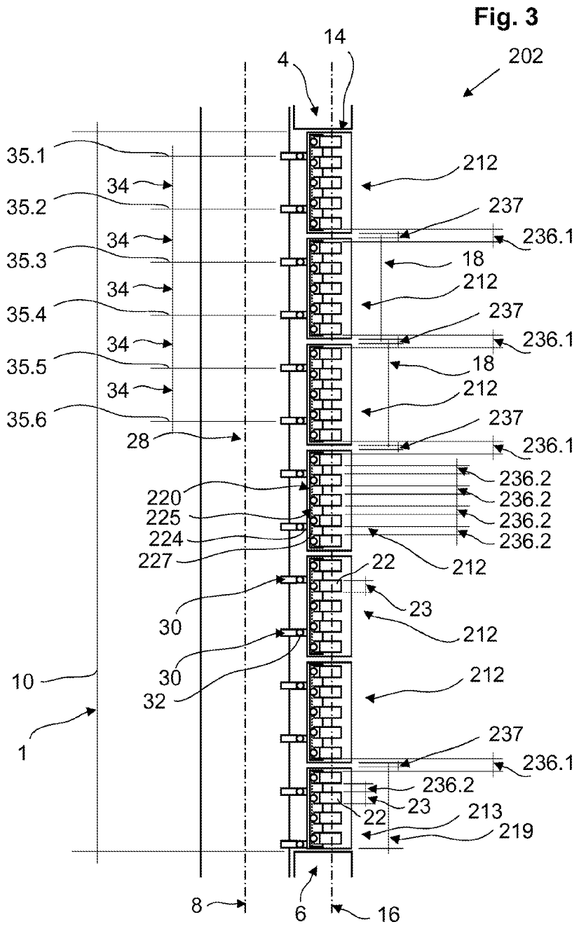

FIG. 3 a shaft track of an elevator system between two exchange sites, comprising a stator rail with multiple stator rail segments according to a third exemplary embodiment of the invention in a lateral sectional view; and

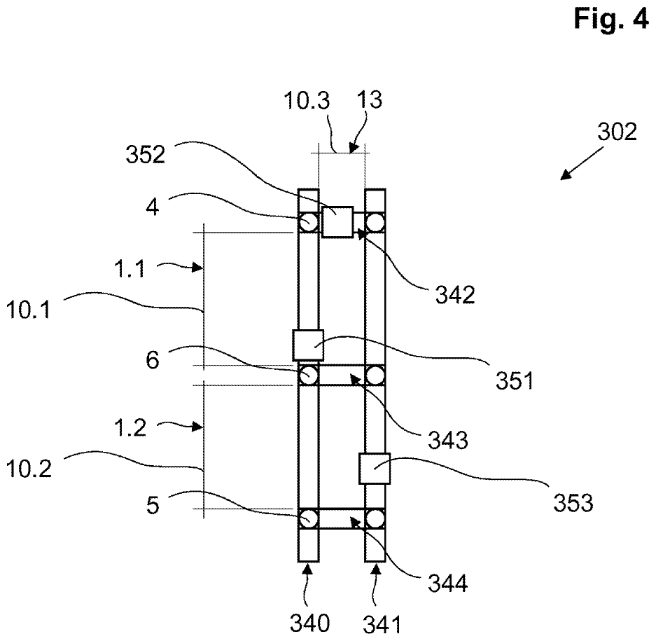

FIG. 4 an elevator system according to one embodiment of the invention with two vertical and three horizontal elevator shafts in a greatly simplified sectional view.

FIG. 1 shows a shaft track 1 of an elevator system 2 between two exchange sites 4 and 6 designed as direction changers (exchangers), being only represented schematically. Extending along a travel axis 8 for substantially the entire track length 10 of the shaft track 1 are multiple adjacently situated stator rail segments 12, which together form the stator rail 14 of the elevator system 2. The stator rail segments 12 are oriented with their drive axis 16 parallel to the travel axis 8. All the stator rail segments 12 comprise at least substantially the same design and thus also the same segment length 18.

Each of the stator rail segments 12 in the exemplary embodiment shown comprises six coil interfaces 20, in which each time a coil unit 22 is contained and connected. The heads of the coil units 22 form that portion of the stator rail 14 which interacts with the rotor of the elevator car for the propulsion of the elevator car, not shown.

Each of the stator rail segments 12 furthermore comprises two shaft interfaces 24 and 26 in the exemplary embodiment, respectively comprising a position adapter 25 and 27 configured as an oblong hole, the oblong hole being formed each time with its lengthwise axis parallel to the travel axis 8 and the drive axis 16.

FIG. 1 also shows the shaft wall 28, comprising each time an anchor rail 30 at given, constant spacings 34, especially at the anchor rail positions 35.x, where a stator rail segment 12 can be secured with a shaft interface 24 or 26. The stator rail segments 12 are secured in their respective assembly position by means of screw connections 32 each time between a shaft interface 24, 26 (at the suitable location of the oblong hole 25, 27) and an anchor rail 30 or by another advisable connection technique in the individual case.

In the exemplary embodiment, the segment lengths 18 of the stator rail segments 12 and the spacing 34 of the anchor rails 30 do not match up, because the anchor rail spacing 34 is dictated by the building owner, while the segment length 18 is dictated by the maker of the elevator system 2.

Thanks to the oblong holes 25, 27 of the shaft interfaces 24, 26 of the stator rail segment 12, despite this lack of a matching, it is possible to adapt the assembly position of each individual stator rail segment 12 so that the stator rail segments 12 can be mounted with always the same spacing (segment spacing) 36 between every two adjacent stator rail segments 12.

This segment spacing 36 is larger than the otherwise required minimum air gap between adjacent stator rail segments 12. This larger, adapted air gap (corresponding to the segment spacing 36) makes possible a uniform distribution of stator rail segments 12 along the entire shaft track 1, even when the nominal dimension (standard segment length times the number of segments plus the sum of the minimum air gaps) does not correspond to the track length 10.

Prior to the installation, it is first of all determined how many stator rail segments 12 with the particular standard segment length 18 can be installed at most along the predetermined track length 10. Then the remaining overall air gap is determined from this and divided evenly among all the individual air gaps 36 between two adjacent stator rail segments.

For the installation itself, the stator rail segments 12 are screwed onto the anchor rails, adapting the assembly position of each stator rail segment 12 in the travel direction 8 to the ascertained individual air gap 36 by means of the position adapter 25, 27.

The exemplary embodiment of FIG. 2 differs from that of FIG. 1 in particular in that a mounting profile with a plurality of assembly recesses 127 evenly distributed and spaced apart from each other along the drive axis 16 is used as the position adapter 125. The mounting profile 125 extends substantially along the entire standard length 18 of the stator rail segments 112 used.

In addition, the stator rail segment 112 of FIG. 2 differs from that of FIG. 1 in that a running rail segment 138 is additionally provided for guiding the elevator car of the elevator system 102. In the exemplary embodiment, the shaft interface 124 is arranged with the mounting profile 125 on this running rail segment 138, or more precisely on its running rail bracket 139. However, a mounting independent of the running rail segment 138 can also be provided.

The stator rail segments 112 are secured in their respective assembly position by means of screw connections 32 each time between a shaft interface 124 (at the suitable assembly recess 127) and an anchor rail 30 or by another advisable connection technique in the individual case. The mounting method including the preceding steps corresponds to that of FIG. 1.

The exemplary embodiment of FIG. 3 shows an adapting of the assembly position of the stator rail segments 212, 213 by means of a position adapter 225 at the coil interfaces 220, which in the exemplary embodiment are configured together with a mounting profile 225—at least in regard to the securing of the coil units—that extends substantially along the entire segment length 18, 219.

The adapting of the assembly position here does not occur by means of the shaft interface 224. That is fixed in position and only enables a mounting of the stator rail segments 212, 213 on the anchor rails 30 with the minimum air gap 237 to equalize any subsidence of the building and thermal expansion of the rail components.

Instead, the individual coil units 22 can be screwed (or otherwise attached) into a plurality of assembly recesses 227 along the drive axis 16 of the individual stator rail segments 212, 213 and be connected there. The connecting of the coil units 212, 213 is not represented in FIG. 3 and occurs in familiar fashion.

Thanks to the adapting of the assembly position of the coil units 212, 213, in the optimal case one can ensure that all pairs of adjacent coil units 212, 213 are spaced apart from each other with a substantially identical air gap 236, even in the case of adjacent coil units on different stator rail segments. In the exemplary embodiment shown, the spacing and thus the air gap 236.1 of adjacent coil units 212, 213 on different stator rail segments is slightly greater than the spacing and thus the air gap 236.2 between adjacent coil units on a stator rail segment. Even so, the distribution of the coil units is relatively uniform.

In order to achieve a complete stator rail 14 for the shaft track 1 despite the fixed assembly position of the standard stator rail segments 212, there is provided in the exemplary embodiment a termination stator rail segment 213 differing from the standard segment length 18, here for example with only four coil units 22 and a shorter termination segment length 219.

Prior to the installation, at first the maximum number of standard coil units 22 of a standard coil length 23 that can be built along the predetermined track length 10 is determined. From this, an overall air gap is determined, which among all the individual air gaps 236 between two adjacent coil units (possibly separated into adjacent coil units on a stator rail segment and adjacent coil units on two stator rail segments).

For the installation itself, the coil units are screwed onto stator rail segments 212 of the standard segment length 18 and the termination stator rail segment 213 of adapted length 219, adapting the assembly position of each coil unit 22 in the drive direction 16 to the ascertained individual air gap 236 by means of the mounting profile. Then the stator rail segments 212, 213 are mounted with a predetermined minimum air gap 237 on the anchor rails 30.

FIG. 4 shows an elevator system 302 according to one embodiment of the invention with two vertical elevator shafts 340, 341 and three horizontal elevator shafts 342, 343, 344. There is situated at each intersection between the elevator shafts an exchange site 4, 6, 5 designed as an exchanger for changing the direction of travel of the elevator cars 351, 352, 353. In the exemplary embodiment shown, the elevator system 302 comprises three elevator cars.

Every two exchange sites 4, 6, 5 bound a shaft track 1.1, 1.2, 1.3 with a track length 10.1, 10.2, 10.3 dictated by the building geometry and the position of the exchange sites.

### LIST OF REFERENCE NUMBERS

1 Shaft track
2, 102, 202, 302 Elevator system
4, 5, 6 Exchange sites
8 Travel axis
10 Track length
12, 112, 212 Standard stator rail segment
213 Termination stator rail segment
14 Stator rail
16 Drive axis
18 Standard segment length
219 Termination segment length
20, 220 Coil interface
22 Coil unit
23 Coil length
24, 26, 124, 224 Shaft interface
25, 27 Position adapter (oblong hole)
125, 225 Position adapter (mounting profile)
127, 227 Assembly recesses
28 Shaft wall
30 Anchor rail
32 Screw connection
34 Anchor rail spacing
35 Anchor rail position
36, 236 Stator rail segment spacing (air gap)
138 Running rail segment
139 Running rail bracket
340, 341 Vertical elevator shaft
342, 343, 344 Horizontal elevator shaft
351, 352, 353 Elevator cars

1.-11. (canceled)

12. A stator rail segment for a linear drive of an elevator system along a drive axis, the stator rail segment having a predetermined segment length, the stator rail segment comprising:
coil interfaces disposed along the drive axis for receiving a respective coil unit;
a shaft interface for securing the stator rail segment in an elevator shaft at a given assembly position with respect to the drive axis; and
a position adapter for adapting an assembly position of the coil units relative to the drive axis relative to the given assembly position, wherein the position adapter comprises an oblong hole that extends parallel to the drive axis.

13. The stator rail segment of claim 12 wherein the position adapter comprises a mounting profile with assembly recesses that are spaced apart from each other along the drive axis.

14. The stator rail segment of claim 12 wherein the position adapter is disposed at the shaft interface.

15. The stator rail segment of claim 14 comprising a running rail bracket for guiding a running rail segment of the elevator system, wherein the running rail bracket comprises the shaft interface.

16. The stator rail segment of claim 14 wherein the position adapter is disposed at the coil interfaces.

17. The stator rail segment of claim 14 comprising a running rail segment for guiding an elevator car of the elevator system.

18. A method for installing a stator rail comprised of multiple of the stator rail segment of claim 14 along a shaft track with a predetermined track length, the method comprising:
determining a maximum number of the stator rail segments of a predetermined segment length that can be built along the predetermined track length;
determining a remaining overall air gap based on differences between the predetermined track length and a sum of the predetermined segment lengths;
dividing the overall air gap equally among all individual air gaps between two adjacent stator rail segments; and
mounting the stator rail segments on anchor rails and adapting the given assembly position of each stator rail segment in a travel direction to the individual air gap so determined by way of the position adapter.

19. A method for installing a stator rail comprised of multiple of the stator rail segment of claim 16 along a shaft track with a predetermined track length, the method comprising:
determining a maximum number of coil units of a predetermined coil length that can be built along the predetermined track length;
determining a remaining overall air gap based on a difference between the predetermined track length and a sum of the predetermined coil lengths;
dividing the overall air gap equally among all individual air gaps between two adjacent coil units;
mounting the coil units on stator rail segments of a predetermined segment length; and
mounting the stator rail segments on anchor rails with a predetermined minimum air gap.

20. The method of claim 19 comprising, based on the predetermined track length, on at least one termination stator rail segment adapted to a length at an end of the shaft track, adapting the assembly position of each coil unit in a travel direction to the individual air gap so determined by way of the position adapter.

21. An elevator system comprising:
a shaft track extending along a travel axis between two exchange sites that are spaced apart in a shaft;
anchor rails that extend transversely to the travel axis and are disposed at a predetermined anchor spacing for securing a stator rail segment to a shaft wall;
stator rail segments secured to at least one of the anchor rails, the stator rail segments being disposed adjacent to each other along the travel axis such that drive axes of the stator rail segments are oriented to the travel axis, wherein the stator rail segments and/or coil units are positioned with substantially a same size air gap from adjacent stator rail segments and/or adjacent coil units, so that each time an end of one of the stator rail segments and/or of the coil units also lies at least substantially against two ends of the shaft track.

22. The elevator system of claim 21 wherein the shaft is a first shaft, the elevator system comprising a second shaft, wherein the first and second shafts are vertical, wherein the first and second shafts are joined together at least at the two exchange sites by way of horizontal shafts.
